(19) United States
(12) Patent Application Publication
(10) Pub. No.: US 2007/0250726 A1
(43) Pub. Date: Oct. 25, 2007

(54) Method of controlling wakeup frequency in a wireless communication system

(76) Inventors: David Albert Rossetti, Randolph, NJ (US); Subramanian Vasudevan, Morristown, NJ (US); Jialin Zou, Randolph, NJ (US)

Correspondence Address: Lucent Technologies Inc., Docket Administrator - Room 3J-219, 101 Crawfords Corner Road, Holmdel, NJ, 07733-3030, US

(21) Appl. No.: 11/409,760

(22) Filed: Apr. 24, 2006

(51) Int. Cl. G06F 1/32

(52) U.S. Cl. 713/320

(57) ABSTRACT

An access terminal supports both a longer wakeup period and a shorter wakeup period (lower frequency of wakeups and higher frequency of wakeups, respectively) where the time interval over which the short wakeup period is active is prescheduled or enabled based on needs. Thus, when paging of the access terminal is expected to occur within a known interval of time, the access terminal enters a standby mode and is awoken more frequently during that interval.

### TECHNICAL FIELD

This invention relates to wireless communications.

### BACKGROUND OF THE INVENTION

A conventional wireless communication system provides wireless connectivity to numerous access terminals such as cellular telephones, personal data assistants, smart phones, pagers, text messaging devices, global positioning devices, notebook computers, desktop computers, and the like. When an access terminal is not engaged in an active application, it enters an idle or dormant state. While in the idle or dormant state, the access terminal periodically wakes itself up to listen for any incoming paging messages directed to it or to any broadcast messages that are transmitted by the access network with which the access terminal is then associated. Access networks in the wireless communication system may provide connectivity to access terminals located in geographical areas, or cells, associated with the access networks. By entering the idle or dormant state and waking up only periodically to listen for messages, the access terminal is able to conserve substantial power as compared to being active and listening for messages all the time. In certain systems, such as CDMA2000 1x, the access terminal has a long wakeup period of 5 seconds. In a worst case scenario, therefore, the access terminal can remain in the idle or dormant state to up to 5 seconds after a broadcast message has been transmitted or a paging message is sent to it by the access network. Whereas this can be acceptable in most applications, such a long delay is not acceptable for certain delay-sensitive applications as for example, the walkie talkie-like push-to-talk services being offered by many wireless service providers. For such delay-sensitive services where the initiating party expects to be essentially instantaneous connected to the called party, a wakeup period of 400 ms or less is desirable. Waking up an access terminal more frequently, however, will significantly increase its power consumption, thereby requiring the access terminal to be recharged more frequently and shortening battery life.

Wireless systems operating in accordance with CDMA2000, DO Rev A/B currently support a three-tier monitoring state, as is shown in FIG. 1. In this three-tier state, the frequency of wakeups is higher for a fixed interval of time 101 immediately after an access terminal enters the idle state. After that fixed interval, however, the frequency of wakeups decreases for another fixed time interval 102 and then, after that second interval is over, the frequency of wakeups decreases even further to its steady state normal wakeup period of 5 seconds. Although such a three-tiered approach is effective should the access terminal need to be awoken shortly after entering the idle state, once it has entered its steady-state where wakeups occur every 5 seconds, unsatisfactory service will still not be provided to delay-sensitive applications such as push-to-talk or fast data collecting from a group of access terminals.

### SUMMARY OF THE INVENTION

In accordance with an embodiment of the present invention, an access terminal supports both a longer wakeup period and a shorter wakeup period (lower frequency of wakeups and higher frequency of wakeups, respectively) where the time interval over which the short wakeup period is active is prescheduled or enabled based on needs. Thus, when paging of the access terminal is expected to occur within a known interval of time, the access terminal enters a standby mode and is awoken more frequently during that interval. For example, the access terminal of a person on duty during predetermined times may need to be in a standby mode with a short wakeup period during such times where paging can be expected to occur at anytime. There are other situations where there are certain definite times when the access terminal needs to be in a standby mode with a short wakeup period, while at other times the long wakeup period is sufficient. Advantageously, since the access terminal is put into the standby mode with a short wakeup period only during these certain times, and is in its normal mode with a longer wakeup period at the majority of other times, power is conserved and battery life is extended.

In an embodiment, both the value of the normal lower frequency of wakeups and the value of the standby higher frequency of wakeups are preset to the access terminal through an initial call setup process.

In an embodiment, a user of an access terminal locally sets the beginning and ending times of a standby mode, or the start time and duration of the standby mode.

In an embodiment, the access terminal receives a message from the access network specifying the starting local time and duration or end time of the standby mode.

In an embodiment of the invention, the access terminal receives a message from the access network to enable or disable the standby mode.

In an embodiment, a master access terminal schedules the standby mode for another access terminal or a group of access terminals by means of a message sent to the access network that identifies the access terminal(s) to be scheduled for a standby mode and the starting time and duration or end time when the designated access terminal(s) are to be in the standby mode, or the master access terminal sends a message to the access network, which in turn sends a multicast or unicast enabling/disabling message to the designated access terminal to enter of exit the standby mode.

### BRIEF DESCRIPTION OF THE DRAWING

The present invention will be better understood from reading the following description of non-limiting embodiments, with reference to the attached drawings, wherein below:

FIG. 1 shows a prior art three-tied approach to managing the frequency of access terminal wakeups;

FIG. 2 show a scheduled standby mode where an access terminal is awoken more frequently than during the normal mode, in accordance with an embodiment of the invention;

FIG. 3 is a block diagram of a wireless communication system operating in accordance with an embodiment of the invention;

FIG. 4 is a flowchart showing the steps at an access terminal in accordance with an exemplary embodiment of the invention; and

FIG. 5 is a flowchart showing within an access network in accordance with an exemplary embodiment of the invention.

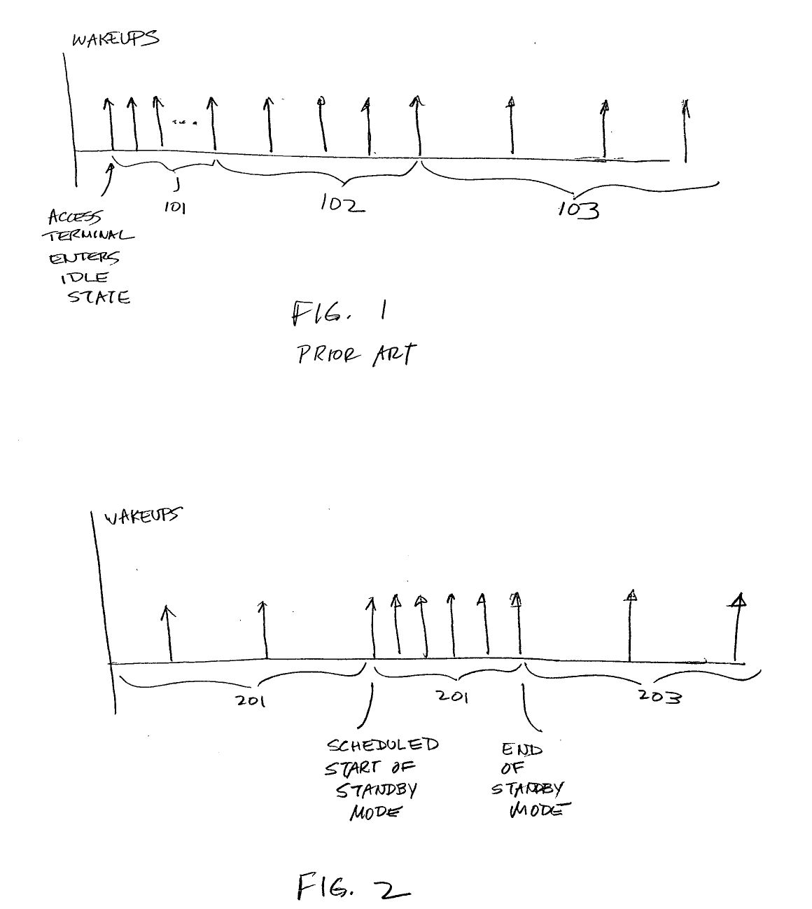

### DETAILED DESCRIPTION

As previously noted, there are many delay-sensitive applications where a connection needs to be immediately established by an access network with an access terminal. If the access terminal has a long wakeup period, satisfactory service may not be provided. A shorter wakeup period during which the frequency of wakeups is higher is desired for such applications. There would be a deleterious effect on power consumption and battery life if an access terminal were to always use such higher frequency of wakeups. In many instances, the times can be predicted at which an access terminal needs to be “at the ready” to respond to paging. For example, a user of an access terminal may be on duty during a certain known time interval during which they need to standby expecting paging anytime; a push-to-talk teleconference controlled by a moderator may be scheduled to start within a known window of time; during emergency situations off duty personal may need to be on standby ready to be contacted. There may be other situations where fast data collecting from a group of access terminals is scheduled at specific times.

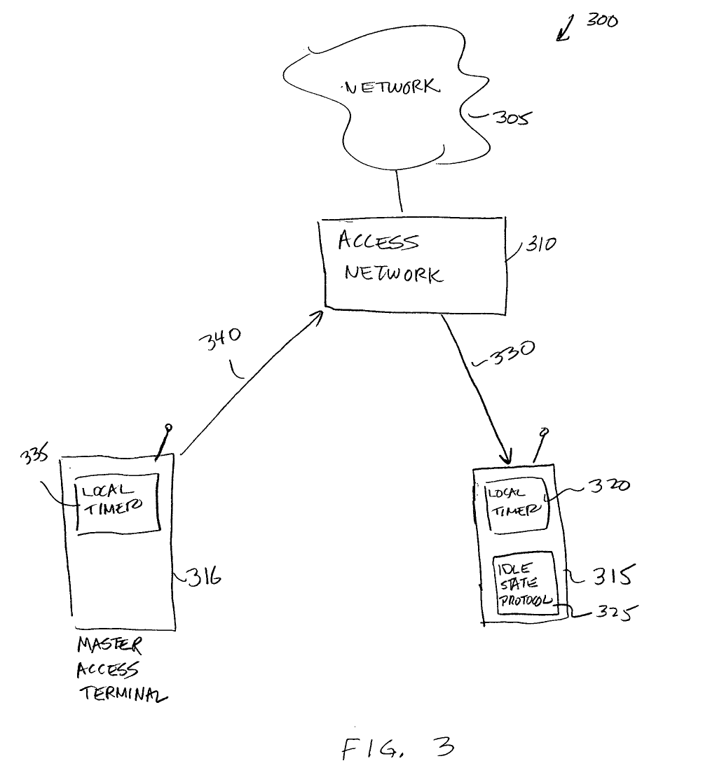

With reference to FIG. 2, during a scheduled time interval 201, an access terminal enters a standby mode where its frequency of wakeups is higher than the frequency of wakeups in the access terminal's normal mode during adjoining time periods 202 and 203. For example, while in the normal mode during time periods 203 and 203, the wakeup period may be an exemplary 5 seconds, and during time interval 201 when the access terminal is in the standby mode, the wakeup period may be 400 ms. Although not shown, after being in a standby mode, for a predetermined time thereafter the access terminal can transit through one or more transitional modes where the frequency of wakeups is step-by-step or continuously reduced from its highest wakeup frequency to its normal wakeup frequency.

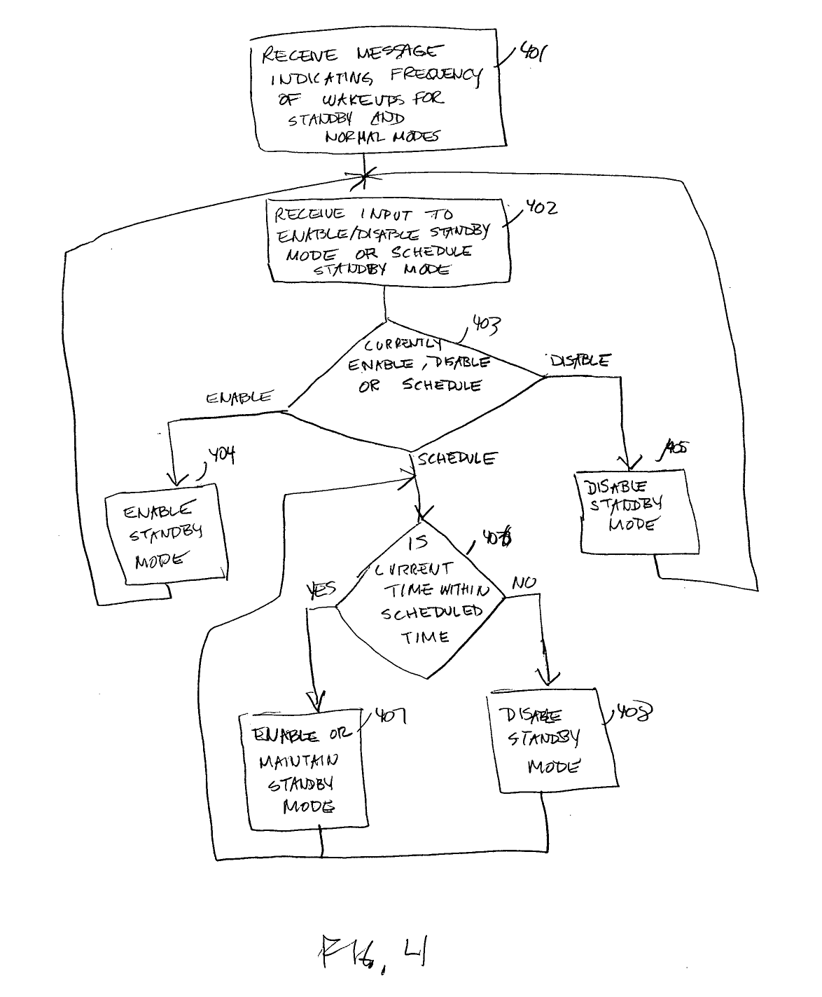

FIG. 3 shows an exemplary embodiment of wireless communication system 300. The wireless communication system includes a network 305. The network may operate according on or more standards or protocols such as the Universal Mobile Telecommunication System (UMTS), the Global System for Mobile communications (GSM), Code Division Multiple Access (CDMA, CDMA2000), and the like. Persons or ordinary skill in the art should appreciate that the network 305 may include wired portions that operate according to one or more wired protocols. However, the particular standards, protocol, or combinations thereof are matter of design choice and not material to the present invention.

One or more access networks 310 may be communicatively connected to the network 305 and are used to provide wireless connectivity in the wireless communication system 300. Although a single access network 310 is shown in FIG. 3, it should be readily appreciated by those of ordinary skill in the art that any number of access networks 310 may be deployed in the wireless communication system 300. Those of ordinary skill in the art should also appreciate that the present invention is not limited to wireless communication systems that include access network 310. In alternative embodiments, the wireless communication system 300 may include other devices (such as radio network controllers) for providing wireless connectivity. Techniques for configuring and/or operating the access networks 310 are known to those of ordinary skill in the art and in the interest of clarity, only those aspects of access network that are relevant to the present invention will be discussed further herein.

FIG. 3 shows an illustrative access terminal 315 that is deployed within the wireless communication system 300. In addition, a master access terminal 316, whose functions will be described herein after is also shown deployed within wireless communication system 300. Although only access terminals 315 and 316 are explicitly shown in FIG. 3, it should be appreciated by those of ordinary skill in the art that any number of access terminals, both non-master and master may deployed in the wireless communication system 300. Persons of ordinary skill in the art should also appreciate that access terminals, such as access terminals 315 and 316, may also be referred to using terms such as “mobile unit,” “mobile station,” “user equipment,” “subscriber station,” “subscriber terminal,” and the like. Exemplary access terminals, such as access terminals 315 and 316, include, but are not limited to cellular telephones, personal data assistants, smart phones, pagers, text messaging devices, global positioning devices, network interface cards, notebook computers, and desktop computers. Techniques for configuring and/or operating access terminals, such as access terminals 315 and 316, are known in the art and in the interest of clarity only those aspects of configuring and/or operating these access terminals that are relevant to the described embodiment of the invention will be discussed further herein.

In the described embodiment, access terminal 315 is in communication with access network 310. When access terminal 315 is no longer actively communicating with access network 310, however, it enters an idle or dormant state. In accordance with an embodiment of the present invention, during the idle or dormant state, mobile terminal will operate in either a normal mode where it listens for paging messages transmitted to it by access network 310, or broadcast by access network 310, where the wakeup period is, for example, every 5 seconds. Alternatively, in a scheduled or enabled standby mode, mobile terminal wakes up, for example, every 400 ms. The different periodicities for the normal and the standby modes are, in this exemplary embodiment, downloaded to mobile terminal 310 from access network 310 through an initial call setup process.

Mobile terminal 310 includes a local timer 320 and an idle state protocol 325. In accordance with an embodiment, idle state protocol sets the start and stop times at which mobile terminal 310 is to be in the standby mode and thus operate with the exemplary 400 ms wakeup period rather than the normal exemplary 5 second wakeup period of the. Various mechanisms for setting the scheduled start and stop times of the standby mode, or initiating and terminating the standby mode, can be implemented.

In a first implementation, a user of access terminal 315 locally sets the start time and either the duration of or the stop time of the standby mode using the local timer 320 as a reference clock. Alternatively, the user can enable the standby mode in real time and the access terminal will remain in that mode until the user disables it.

In a second implementation, the start and stop or duration times of the standby mode are set through a standby configuration message received by access terminal 315 from access network 310 over a control channel 330. That message can be a regular control channel message that specifies the starting local time and the end time or duration of the standby mode. Alternatively, a short multicast or unicast control message can be used to instruct the recipient access terminal(s) to enable or disable the standby state. In either case, the standby configuration message will need to be understood by the access terminal 315, and the access network 310 will need to formulate the appropriate control messages that will instruct the access terminal as to when it should schedule the standby mode or to enter the standby mode upon receiving such a message.

In an embodiment of the present invention, access network 310 receives the information for scheduling or enabling the standby mode of access terminal 315 from master access terminal 316. The master access terminal 316, which has its own internal local timer 335, sends a scheduled standby request message to access network 310 over the traffic channel 340. That message specifies the identity of the one or more access terminals to which the message applies, and the starting local time and duration or end time when the access terminal is to be put into the standby mode. The access network will interpret that message and create the afore noted standby configuration message, which is send to the targeted access terminals through the control channel. Alternatively, the master access terminal 316 will issue a short multicast or unicaste enable/disable standby message, which contains the IDSs of the one or more access terminals and an enable/disable indication only. The access network 310, recognizing the format of that message from the master access terminal 316, then sends the short standby control message to the identified access terminal(s) 315 to enable/disable the standby mode.

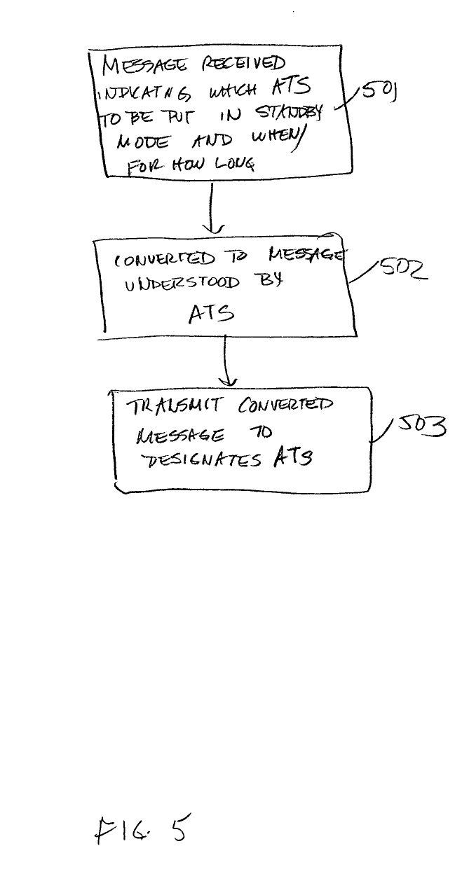

FIG. 4 shows the steps at an access terminal in accordance with an exemplary embodiment. At step 401, the access terminal receives an message indicating the frequency of wakeups for the standby mode and normal modes, unless one or more of such frequencies are permanently set and stored in the access terminal. At step 402, an input is received to currently enable or disable the standby mode of wakeup frequency or to schedule a time when the standby mode is to be enabled. If, at step 403, the input is to currently enable the standby mode, then access terminal enables the standby mode at step 404, and thereafter awaits a next input to disable the standby mode. If, at step 403, the input is to currently disable the standby mode, then, at step 405, the standby mode is disabled and the normal mode of wakeup frequency is invoked. If, at step 403, the input indicates a scheduled time during which the standby mode is to be invoked, then, at step 406, a determination is made whether the current local time is within that scheduled time. If the current time is within the scheduled time, then, at step 407, and the access terminal is currently in the idle or dormant state, the standby mode is enabled if the access terminal is not already in it. If the current time is outside the scheduled time, then, at step 408, then if the access terminal is in the normal mode, it remains there, or if it is in the standby mode, the standby mode is disabled and the normal mode is enabled. The flow returns to step 406 after either step 407 or 408, to compare the current local time with the standby mode's scheduled time.

FIG. 5 shows the steps taken within the access network in accordance with an exemplary embodiment. At step 501, a message is received indicating which access terminals are to be put into a standby mode and when and for how long they are to be in that mode. At step 502, the received message is converted to a message that will be understood by the access terminals to which it is intended. At step 503, the converted message is transmitted to the designated access terminals on the control channel.

The above-described embodiments are illustrative of the principles of the present invention. Those skilled in the art can devise other embodiments without departing from the spirit and scope of the invention.

The invention claimed is:

1. A method at an access terminal in a wireless communication system, the method comprising:
in response to receiving an input from a source external to the access terminal, initiating at certain time a standby mode of operation where when the access terminal is in an idle or dormant state the frequency of wakeups is greater than the frequency of wakeups in a normal mode of operation.

2. The method of claim 1 further comprising receiving an indication of the frequency of wakeups for the standby mode.

3. The method of claim 1 wherein the input is an input from a user that indicates when the access terminal is to operate in the standby mode.

4. The method of claim 3 wherein the input from the user indicates a start time and an end time or a duration of when the access terminal is to operate in the standby mode.

5. The method of claim 3 wherein the input from the user enables the standby mode when the input is received.

6. The method of claim 5 further comprising an input from the user disabling the standby mode when it is received.

7. The method of claim 1 wherein the input is a message received over the air on a control channel.

8. The method of claim 7 wherein the message indicates a time when the access terminal is to operate in the standby mode.

9. The method of claim 8 wherein the message indicates that the standby mode is to be enabled.

10. The method of claim 11 further comprising receiving a message indicating that the standby mode is to be disabled.

11. The method of claim 8 wherein the message indicates a start time and a duration or an end time of when the access terminal is to operate in the standby mode.

12. A method in a wireless communication system in which an access network is communicating with at least one access terminal, the method comprising:
sending a message indicating that at a certain time an access terminal should operate in a standby mode of operation where during an idle or dormant state the frequency of wakeups is greater than the frequency of wakeups during a normal mode of operation.

13. The method of claim 12 wherein the message indicates that the standby mode should be enabled.

14. The method of claim 13 further comprising sending a message indicating that the standby mode should be disabled.

15. The method of claim 12 wherein the message indicates a start time and an end time or a duration of the standby mode.

16. The method of claim 12 wherein the message identifies one or more access terminals to which the message is directed.

17. The method of claim 16 wherein the identification of the one or more access terminals is received from a master access terminal.

18. The method of claim 12 wherein the certain time that the access terminal should operate in the standby mode is received from a master access terminal.

19. A method at an access terminal in a wireless communication system, the method comprising:
sending a message indicating that at a certain time another access terminal should initiate a standby mode of operation where when the other access terminal is in an idle or dormant state the frequency of wakeups is greater than the frequency of wakeups in a normal mode of operation.

20. The method of claim 19 wherein the message further indicates an identity of the other access terminal.

21. The method of claim 19 wherein the message indicates a start time and an end time or a duration of the standby mode.

22. The method of claim 19 wherein the message indicates that the other access terminal should enable the standby mode.

23. The method of claim 22 further comprising sending a second message indicating that the other access terminal should disable the standby mode.
